(19) United States
(12) Patent Application Publication
(10) Pub. No.: US 2008/0008932 A1
(43) Pub. Date: Jan. 10, 2008

(54) NON-AQUEOUS ELECTROLYTE SECONDARY BATTERY

(75) Inventor: Shinji KASAMATSU, OSAKA (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/772,951

(22) Filed: Jul. 3, 2007

(30) Foreign Application Priority Data
Jul. 4, 2006 (JP) 2006-184042

(51) Int. Cl. H01M 2/16

(52) U.S. Cl. 429/144; 429/129

(57) ABSTRACT

In a non-aqueous electrolyte secondary battery including a positive electrode, a negative electrode, and a separator, the separator is immersed in a non-aqueous electrolyte, and the separator contains an aromatic resin and an antistatic agent. The precision upon rolling out a reel-like rolled product of the separator is thus improved, and winding misalignment in separators decreases. Also, minute short circuit occurrence decreases drastically. As a result, a reliable quality, high capacity non-aqueous electrolyte secondary battery can be efficiently and advantageously manufactured.

### FIELD OF THE INVENTION

The present invention relates to non-aqueous electrolyte secondary batteries.

### BACKGROUND OF THE INVENTION

Recently, consumer electronic devices are rapidly becoming portable and wireless. For power sources for driving these electronic devices, secondary batteries are mainly used. Particularly, lithium ion secondary batteries using lithium ions as migration carrier are widely used as power sources for laptop personal computers, mobile phones, and AV devices, because of its high electromotive force and energy density and relative ease in downsizing and weight reduction. Lithium ion secondary battery market is expected to grow further bigger.

Lithium ion secondary batteries include a positive electrode, a negative electrode, and a separator. The separator is provided between the positive electrode and the negative electrode, electrically insulating the positive electrode and the negative electrode, while retaining an electrolyte. For the separator of lithium ion secondary batteries, porous films of polyolefin, i.e., a thermoplastic resin, are mainly used in view of safety. To be specific, for the separator, a porous film of for example polyethylene and polypropylene is used. These porous films have a shutdown function, by which the pores formed therein for ion passageways are closed when the battery temperature becomes high to stop battery operation, securing battery safety.

Various techniques are proposed for improvement in polyolefin-made porous films. For example, the specification of Japanese Patent No. 3175730 describes a separator in which a polyolefin-made porous film and a heat-resistant layer including an aromatic resin such as an aramid resin are stacked. This technique aims to further improve battery safety by maintaining the shutdown function of the polyolefin-made porous film, while further improving the heat-resistance of the porous film. However, this separator is disadvantageous in that its usage in the form generally distributed is difficult.

That is, separators are conventionally distributed as a reel-like rolled product, and this rolled product is generally inserted between the positive and negative electrodes to form an electrode assembly, after the rolled product is rolled out. However, it is difficult to precisely roll out the rolled product of the separator disclosed in the specification of Japanese Patent No. 3175730, and a misalignment is easily caused in the rolling of the electrode assembly upon forming the electrode assembly. Such a tendency is particularly notable in an environment in which conductive dust is removed (for example, clean level of class 5000 to 10000, dust with a diameter of 0.3 μm or more). Thus, when using the separator disclosed in the specification of Japanese Patent No. 3175730, reliability declines in terms of the lithium ion secondary battery quality to be obtained.

On the other hand, a technique to use surfactants for the separator of lithium ion secondary batteries is known conventionally. For example, Japanese Laid-Open Patent Publication No. 2006-73221 describes a lithium ion secondary battery separator of a composite porous film having a layer comprising polyvinylidene fluoride with a surfactant applied on the surface thereof. In this technique, the surfactant application to highly charging polyvinylidene fluoride prevents dust from attaching to polyvinylidene fluoride upon battery manufacturing. However, the effects are not sufficiently satisfying level.

Japanese Laid-Open Patent Publication No. 2004-79515 describes an application of a surfactant to the surface of the separator comprising a polyolefin-made porous film in a lithium polymer secondary battery. In this technique, a surfactant is applied to the separator to accelerate penetration of the electrolyte into the separator. Additionally, in batteries other than lithium ion secondary batteries as well, the surfactant application to the separator surface for making it lyophilic is general.

However, by merely applying a surfactant to the surface of the separator comprising a resin-made porous film, minute short circuit occurrence due to dust attached to the separator cannot be prevented when the electrode assembly is formed by stacking the positive electrode, the separator, and the negative electrode. The minute short circuit causes problems such as battery self-discharge and decline in the battery capacity (minute short circuit defect or OCV defect).

### BRIEF SUMMARY OF THE INVENTION

The present invention aims to provide a high capacity non-aqueous electrolyte secondary battery that has excellent heat-resistance; includes a separator whose reel-like rolled product can be precisely rolled out; can be effectively manufactured due to much less occurrence of misalignment in rolling upon forming an electrode assembly; drastically decreases minute short circuit occurrence; and has highly reliable quality and safety.

In the process of research for solving the above problem, the present inventors found out that when a separator containing an aromatic resin is to be wound into a reel, the aromatic resin easily build up electrostatic, and when the electrostatic is built up in the aromatic resin, the precision upon rolling out the reel-like rolled product declines, leading to a tendency of frequent occurrence of misalignment in winding the electrode assembly. The present inventors further researched based on such new findings, and found out that when an antistatic agent is contained in the separator along with the aromatic resin, an improvement is achieved in precision of rolling out the rolled product without declining various characteristics of the non-aqueous electrolyte secondary battery. Further, unexpectedly, it was found that occurrence of minute short circuit defects by the dust attached upon forming the electrode assembly is drastically decreased, when an aromatic resin and an antistatic agent is used together in the separator, and the present invention is completed.

That is, the present invention provides a non-aqueous electrolyte secondary battery including a positive electrode, a negative electrode, and a separator containing an aromatic resin and an antistatic agent.

The aromatic resin preferably contains in its molecule at least one bond selected from the group consisting of an aramid bond, an amide imide bond, an amide bond, an imide bond, a sulfide bond, and a carbonyl bond.

The aromatic resin is preferably at least one selected from the group consisting of an aramid resin, polyamide-imide, and polyimide.

The separator preferably includes a separator body and an antistatic layer provided on at least one side of the separator body in the thickness direction thereof.

In another embodiment, the separator preferably contains an antistatic agent in the separator body.

The antistatic agent has preferably a molecular weight of 10000 or less.

The antistatic agent is preferably at least one selected from the group consisting of an anionic surfactant, a cationic surfactant, an amphoteric surfactant, and a non-ionic surfactant.

The non-aqueous electrolyte is preferably a non-aqueous electrolyte liquid.

The present invention achieves a non-aqueous electrolyte secondary battery including a separator which has high heat-resistance, causes much less minute short circuit, and enables precise rolling out even if the separator is wound like a reel. A non-aqueous electrolyte secondary battery of the present invention is reliable in terms of quality and safety, has a high capacity, and can be produced efficiently.

Based on the present invention, high quality reliability can be given to non-aqueous electrolyte secondary batteries for any use with better productivity. Therefore, techniques disclosed in the present invention are highly applicable industrially, and effects thereof are significant.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic cross section view showing the structure of a lithium ion secondary battery in an embodiment of the present invention.

FIG. 2 is a side view showing the structure of a separator used in the present invention.

FIG. 3 is a side view showing the structure of another separator used in the present invention.

### DETAILED DESCRIPTION OF THE INVENTION

A non-aqueous electrolyte secondary battery of the present invention includes a separator containing an aromatic resin and an antistatic agent; and the positive electrode, the negative electrode, and elements other than these may be formed in the same manner as conventional non-aqueous electrolyte secondary batteries.

The positive electrode includes, for example, a positive electrode current collector and a positive electrode active material layer. For the positive electrode current collector, those positive electrode current collectors generally used in the field of non-aqueous electrolyte secondary batteries (hereinafter referred to as “this field”) may be used, and for example, a porous or non-porous conductive substrate may be mentioned. For the material forming the conductive substrate, for example, metal materials such as stainless steel, titanium, aluminum, and nickel, and a conductive resin may be used. The positive electrode current collector is preferably formed with a foil, a sheet, and a film. When the positive electrode current collector is a foil, a sheet, or a film, its thickness is not particularly limited, but preferably 1 to 50 μm and further preferably 5 to 20 μm.

The positive electrode active material layer is provided on at least one surface of the positive electrode current collector in the thickness direction thereof; includes a positive electrode active material; and further includes a binder and a conductive agent as necessary. For the positive electrode active material, those positive electrode active materials generally used in this field may be used. In the case of a lithium ion secondary battery as an example of non-aqueous electrolyte secondary batteries, for the positive electrode active material, for example, a lithium-containing composite metal oxide, a transition metal chalcogen compound, a vanadium oxide and its lithium compound, a niobium oxide its lithium compound, a conjugated polymer including an organic conductive material, a Chevrel phase compound, and a combination of two or more thereof may be mentioned. The lithium-containing composite metal oxide is an oxide including at least one metal element other than vanadium and niobium along with lithium. The specific examples of these include, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄ (M is at least one selected from the group consisting of Na, Mg, Sc, Y, Mn, Fe, Co, Ni, Cu, Zn, Al, Cr, Pb, Sb, and B. x=0 to 1.2, y=0 to 0.9, and z=2.0 to 2.3) may be mentioned. The value shown by x is the value before starting charge and discharge, and increases and decreases by charge and discharge. The positive electrode active material is preferably particulate, and without limitation, its average particle size is preferably 1 to 30 μm.

For the binder, for example, polytetrafluoroethylene (hereinafter referred to as “PTFE”), modified acrylonitrile rubber particles (product name: BM-500B, manufactured by Zeon Corporation), carboxymethyl cellulose (hereinafter referred to as “CMC”), polyethylene oxide, a soluble modified acrylonitrile rubber (product name: BM-720H, manufactured by Zeon Corporation), polyvinylidene fluoride (hereinafter referred to as “PVDF”) and modified PVDF may be mentioned. Two or more of these binders may be combined for use. For example, a combination of PTFE or modified acrylonitrile rubber particles, and CMC, or a soluble modified acrylonitrile rubber with thickening effects is preferable. A combination of PVDF and modified PVDF with excellent binding and thickening effects is also preferable. For the conductive agent, for example, acetylene black, ketjen black, various graphites, and combination of two or more of these may be mentioned.

The negative electrode includes, for example, a negative electrode current collector and a negative electrode active material layer. For the negative electrode current collector, those generally used in this field may be used. For example, a porous or non-porous conductive substrate may be mentioned. For the conductive substrate material, for example, metal materials such as stainless steel, nickel, and copper, and a conductive resin may be used. The negative electrode current collector may be formed with a foil, a sheet, and a film. When the negative electrode current collector is a foil, a sheet, or a film, its thickness is not particularly limited, but preferably 1 to 50 μm and further preferably 5 to 20 μm.

The negative electrode active material layer is provided on at least one surface of the negative electrode current collector in the thickness direction thereof, includes a negative electrode active material, and further includes a binder and a conductive agent as necessary. In the case of a lithium ion secondary battery as an example of non-aqueous electrolyte secondary batteries, for the negative electrode active material, for example, graphite materials such as natural graphite and artificial graphite; a silicon composite material such as silicide; a lithium alloy material including at least one metal element selected from the group consisting of tin, aluminum, zinc, and magnesium; an alloy material other than the above mentioned; and a combination of two or more of the above may be mentioned.

For the binder, various resin materials generally used in this field may be used, but particularly, a combination of styrene-butadiene copolymer (hereinafter referred to as “SBR”) and a cellulose-type resin such as CMC, PVDF, and modified PVDF are preferable. To improve safety in overcharged state, a combination of SBR and a cellulose-type resin is preferable. For the conductive agent, the same conductive agent as the one used for the positive electrode active material layer may be used.

The separator is provided between the positive electrode and the negative electrode, to electrically insulate the positive electrode and the negative electrode, while making a passageway for ions. The separator used in the present invention inevitably includes an aromatic resin and an antistatic agent. By including these at the same time, occurrence of a minute short circuit is drastically decreased, and a high capacity battery which does not easily cause self-discharge is obtained.

The aromatic resin is used to form a separator body to be mentioned later or a heat-resistance porous layer provided on the polyolefin-made porous film surface. The aromatic resin is a resin having high heat-resistance. The heat-resistance means having sufficiently high glass transition point and melting point, and having a sufficiently high thermal decomposition temperature involving a chemical change. Since the heat-resistance is defined as a mechanical strength, the heat distortion temperature measured by a deflection test under load is used as a measure. To be specific, aromatic resins are a resin having a heat distortion temperature of 200° C. or more measured by a deflection test under load (measurement of the deflection temperature under load) with 1.82 Mpa based on ASTM-D648 of American Society for Testing and Materials. When the heat distortion temperature is high, the separator is resistant to deformation by compression and keeps its form.

The aromatic resin is not particularly limited, as long as it includes an aromatic ring and is the resin having the above heat-resistance. Particularly, an aromatic resin including at least one bond selected from the group consisting of an aramid bond, an amide-imide bond, an amide bond, an imide bond, a sulfide bond, and a carbonyl bond in its molecule is preferably used. The aramid bond is a bond by which two aromatic rings are linked via an amide bond. The aromatic ring includes benzene rings, naphthalene rings, and anthracene rings. For example, as shown below, two benzene rings are linked via the amide bond. When the aromatic ring has 10 or more carbons, the linkage is not limited to the linkage at meta-position and para-position, as shown below.

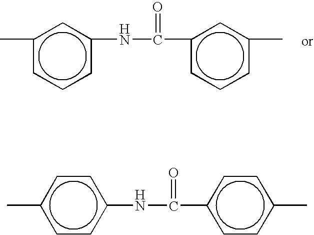

Among such aromatic resins, aramid resins (all aromatic polyamides), polyamide-imides, and polyimides are preferably used, in view of the fact that a porous film with high electrolyte retention ability and heat-resistance is easily formed. The aromatic resin may be used singly, or may be used in combination of two or more as necessary.

For the aramid resin, for example, all aromatic polyamides of para-oriented (hereinafter referred to as “para-aramid”), all aromatic polyamides of meta-oriented (hereinafter referred to as “meta-aramid”) may be mentioned. Particularly, para-aramid is preferable in that it has high mechanical strength and becomes porous easily. The para-aramid is obtained, for example, by a condensation polymerization of aromatic diamine having an amino group at para-position, and aromatic dicarboxylate halide having an acyl group at para-position. Thus, in para-aramids, the amide bond is present at the para-position of the aromatic ring. The para-aramid has, for example, a repetitive unit of 4,4′-biphenylene, 1,5-naphthalene, and 2,6-naphthalene.

For specific examples of the para-aramid, poly(paraphenylene terephthalamide), poly(parabenzamide), poly(4,4′-benzanilide terephthalamide), poly(paraphenylene-4,4′-biphenylene dicarboxylate amide), poly(paraphenylene-2,6-naphthalene dicarboxylate amide), poly(2-chloroparaphenylene terephthal amide), and paraphenyleneterephthalamide/2,6-dichloroparaphenyleneterephthalamide copolymer may be mentioned. These may be used singly, or may be used in combination of two or more.

The antistatic agent is used, for example, for precisely rolling out the reel-like rolled product of the separator including an aromatic resin. Although electrostatic is easily generated when aromatic resins are formed into a sheet and the sheet is wound to give a reel-like form, by the presence of an antistatic agent, the static is eliminated from the separator surface, thereby curbing occurrence of electric charge from the friction of the separator surface. Further, the antistatic agent shows unexpected effects of decreasing minute short circuit occurrence, when used in combination with an aromatic resin.

For the antistatic agent to be used in the present invention, for example, a surfactant having an antistatic effect may be used. Particularly, considering workability at the time of manufacturing the separator, those with a low molecular weight are preferable, and with a molecular weight of 10000 or less are particularly preferable. Specific examples of a low molecular weight surfactant include, for example, anionic surfactants such as alkyl sulfonate, alkyl benzene sulfonate, alkyl sulfonate ester, alkyl ethoxy sulfonate ester, alkyl phosphoric acid ester; cationic surfactants such as alkyl trimethyl ammonium salt, acyloylamide propyltrimethyl ammonium metosulfate, alkylbenzyl dimethyl ammonium salt, acyl choline chloride; amphoteric surfactants such as alkyl betaine type, imidazoline type, alanine type; and non-ionic surfactants such as aliphatic acid alkylor amide, di(2-hydroxyethyl)alkyl amine, polyoxyalkylenealkyl amine, polyoxyalkylenealkyl amine, aliphatic acid glycerine ester, polyoxyalkylene glycol aliphatic acid ester, sorbitan aliphatic acid ester, polyoxyalkylenealkylphenyl ether, and polyoxyalkylenealkyl ether may be mentioned. The antistatic agent may be used singly, or may be used in combination of two or more.

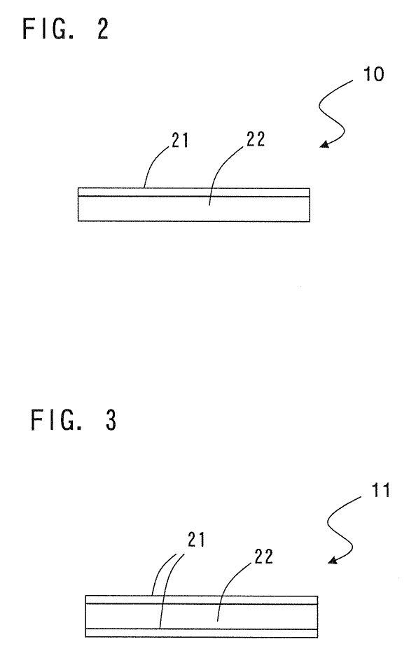

As a specific example of the separator, for example, separator 10,11 including a separator body 22 and an antistatic layer 21 provided on at least one surface of the separator body in the thickness direction thereof (hereinafter referred to as a “first separator”) as shown in the FIGS. 2 and 3, and separator with an antistatic agent contained in the separator body (hereinafter referred to as a “second separator”) may be mentioned. FIG. 2 is a side view showing the structure of a separator used in the present invention. FIG. 3 is a side view showing the structure of another separator used in the present invention.

The separator body in the first separator include, a porous film comprising an aromatic resin, a porous film comprising a mixture of an aromatic resin and polyolefin, and a layered film of a heat-resistant porous film comprising an aromatic resin and a porous film comprising polyolefin. Particularly, the layered film of the heat-resistant porous film and the porous film comprising polyolefin is preferable, since mechanical strength and flexibility of the porous film comprising polyolefin can be used for workability and productivity.

The porous film including an aromatic resin may be manufactured, for example, as in the following. When an aramid resin is used as the aromatic resin, the porous film comprising the aramid resin is obtained by dissolving the aramid resin in a polar solvent, applying the obtained solution on a flat substrate, drying the coating on the substrate, and peeling the coating from the substrate. Known polar solvents may be used. For example, N-methyl-2-pyrrolidone (hereinafter referred to as “NMP”) may be mentioned. For the substrate, for example, a glass plate and a stainless plate may be mentioned. To the solution dissolving the aramid resin in the polar solvent, an inorganic oxide filler may be added. By adding the inorganic oxide filler, the heat-resistance of the separator body can be improved dramatically. A chemically stable and highly pure inorganic oxide filler is preferable for not causing side reaction which adversely affect battery performance even though immersed with the non-aqueous electrolyte and even though under an oxidation-reduction potential. The specific examples include, for example, alumina, zeolite, silicon nitride, silicon carbide, magnesium oxide, zinc oxide, and silicon dioxide may be mentioned.

The porous film including an aromatic resin and polyolefin may be manufactured, for example, in the same manner as manufacturing the porous film comprising an aromatic resin, except that a solution dissolving an aromatic resin and polyolefin in a polar solvent is used.

The layered film of a heat-resistant porous film and a porous film comprising polyolefin may also be manufactured in the same manner as the method for producing the porous film comprising an aramid resin, except that a porous film including polyolefin is used instead of the substrate. For the porous film comprising polyolefin, a microporous thin film having a high degree of ion permeability, a predetermined mechanical strength, and a high nonconductivity is used. The microporous thin film is a film-like structure, in which quite a many pores having micro diameters are formed inside, and preferably, the pores mostly have a diameter in the rage between 0.01 to 5 μm. The porosity is calculated by the formula below:

Porosity (%)={(1−d₁)/d}}×100

where d represents the true density of the microporous thin film. d₁ represents the density of the microporous thin film at 25° C. True density d of the microporous thin film is calculated based on the ratio between constituents included in the microporous thin film and the true density.

This microporous thin film has preferably functions of closing pores at a predetermined temperature or more and increasing resistance. The microporous thin film comprising polyolefin may be formed, for example, by melting polyolefin while applying a shearing force with an extruder under heat, molding this melted product into a wide and thin melted film by allowing the melted product to go through a T-die, and cooling the obtained melted film immediately. For polyolefin, for example, polyethylene, polypropylene, and mixture thereof may be mentioned. Organic product powder and inorganic product powder may be added as well to polyolefin. There powders are dispersed homogenously in melted polyolefin upon usage. Since the organic products are extracted and removed from the microporous thin film by allowing the microporous thin film obtained by the forming to contact an appropriate organic solvent, it is used for example for further creating pores in the microporous thin film. For such organic products, for example, a plasticizer such as dioctyl phthalate, sebacic acid, adipic acid, and trimellitic acid may be mentioned. The inorganic product powder is used, for example, to accelerate the pore formation in the film upon forming the film. The inorganic product powder is removed as well by washing with water after the film formation, to achieve obtaining a porous film with a higher degree of porosity. As the inorganic product powder, for example, calcium carbonate, magnesium carbonate, and calcium oxide may be mentioned. Not limited to the time of forming the microporous thin film, the organic product powder and the inorganic product powder may be used for the same purpose with the above, upon forming a porous film of aramid resin, and a porous film of aramid resin and polyolefin mixture. The microporous thin film obtained by the above film-forming method may be further drawn. The drawing can be carried out for example by uniaxial drawing, sequential or simultaneous biaxial drawing, continuous sequential biaxial drawing, and continuous simultaneous biaxial drawing of continuous tenter clip method. Also, a plurality of the microporous thin films obtained by the above film-forming methods may be stacked and melted by heating to be integrated.

In the layered film comprising a heat-resistant porous film and a porous film comprising polyolefin, a sheet made of polyolefin or glass fiber, nonwoven fabric, and woven fabric may be used instead of the porous film comprising polyolefin. This further improves, for example, resistance to organic solvents and hydrophobivicity of the separator.

In the first separator, an antistatic layer is provided on at least one surface of the separator body obtained as in the above in the thickness direction thereof. The antistatic layer may be formed, for example, by an application method and a bleeding method.

In the application method, a solution or dispersion of the antistatic agent (hereinafter referred to as “application liquid of the antistatic agent”) is applied on the separator body surface, and dried as necessary to form the antistatic layer, thus forming the first separator. The same antistatic agents as exemplified above may be used. The application liquid of the antistatic agent may be prepared, for example, by dissolving or dispersing the antistatic agent in an appropriate solvent. The solvent is not particularly limited, as long as the solvent enables dissolving or dispersing the antistatic agent without denaturation. For example, organic solvents such as water and lower alcohol may be used preferably. The application liquid of the antistatic agent may be applied to the separator body with a known method of applying liquid to the solid surface. For example, spray application, immersion application, and roll application may be mentioned. The application liquid of the antistatic agent is preferably applied so that the amount of the antistatic agent included in the antistatic layer is 0.1 to 0.5 wt % of the amount of the resin in total included in the separator body. When the amount is below 0.1 wt %, there might be a possibility that the effects of antistatic and minute short circuit prevention may not be exhibited sufficiently. Although the antistatic effects are exhibited with the amount exceeding 0.5 wt %, there may be a possibility that not preferable effects may be exhibited, other than the antistatic effects. For example, slipperiness of the first separator surface declines, thus rendering the precise rolling out unachievable when the first separator is wound to give a reel-like form.

In the bleeding method, a separator body is made first in the same manner as above, except that an antistatic agent is included in a raw material, i.e., an aromatic resin and/or polyolefin, upon making the separator body. By applying heat and pressure to this separator body, the antistatic agent in the separator body leaches out (bleeding) to the separator body surface. The first separator is thus obtained. The amount of the antistatic agent to be leached to the separator body can be adjusted by appropriately selecting the temperature, pressure, and time upon heating and pressurizing. In this case as well, the amount of the antistatic agent included in the antistatic layer is preferably 0.1 to 0.5 wt % of the amount of the resin in total included in the separator body.

The second separator contains an antistatic agent in the separator body. The second separator may be manufactured, for example, in the same manner as the above manufacturing method for the separator body by using a raw material mixture including a resin material and an antistatic agent. The resin material includes an aromatic resin, polyolefin, or a mixture thereof. For the antistatic agent, those examples shown above may be used. The antistatic agent may be added, for example, to a polar solvent solution of a resin material, and to a melted, kneaded resin material. In this way, the second separator may be manufactured with fewer steps for low cost. The timing of adding the antistatic agent to the melted, kneaded resin material may be during the melting and kneading of the resin material, and while extruding the melted, kneaded resin material. The amount of the antistatic agent to be added this time is not particularly limited, but preferably 0.05 to 5 wt % of the resin material in total. When the amount is below 0.05 wt %, the antistatic effect and the minute short circuit prevention effect are not sufficiently brought out. When the amount exceeds 5 wt %, there is a possibility that electrical insulation of the second separator declines. The polar solvent solution to which the antistatic agent is added was applied on a flat substrate, and by drying the obtained film, the second separator is obtained. The melted, kneaded material to which the antistatic agent was added is formed into the second separator, for example, by extrusion. The second separator is formed of particularly, for example, a porous film of an aromatic resin and containing an antistatic agent; a porous film of a mixture of an aromatic resin and polyolefin and containing an antistatic agent; a layered film of a heat-resistant porous film of an aromatic resin and a porous film of polyolefin, at least one of the porous film containing an antistatic agent. The antistatic agent may be dispersed in the separator body without limitation, but preferably distributed more at the surface than inside of the separator, in terms of an effect of removing electric charge.

The separator is impregnated with an electrolyte. For the electrolyte, various electrolytes used in non-aqueous electrolyte secondary batteries are used. When a non-aqueous electrolyte secondary battery of the present invention is a lithium ion secondary battery, for example, an electrolyte with lithium ion conductivity may be used for the electrolyte. As an electrolyte with lithium ion conductivity, a non-aqueous electrolyte with lithium ion conductivity is preferable. For the non-aqueous electrolyte, for example, liquid non-aqueous electrolytes, gelled non-aqueous electrolytes, and solid electrolytes (for example, solid polymer electrolyte) may be mentioned.

The liquid non-aqueous electrolyte includes a supporting salt and a non-aqueous solvent, and further includes various additives as necessary.

For the supporting salt, those used in the field of lithium ion secondary batteries are used. For example, LiClO₄, LiBF₄, LiPF₆, LiAlCl₄, LiSbF₆, LISCN, LiCF₃SO₃, LiCF₃CO₂, LiAsF₆, LiB₁₀Cl₁₀, lithium lower aliphatic carboxylate, LiCl, LiBr, LiI, LiBCl₄, borates, and imide salts may be mentioned. Among these, LiPF₆ and LiBF₄ are preferable. The supporting salt may be used singly, or may be used in combination of two or more, as necessary. The amount of the supporting salt to be dissolved relative to the non-aqueous solvent is preferably within the range of 0.5 to 2 mol/L.

For the non-aqueous solvent, those usually used in the field of lithium ion secondary batteries may be used. For example, cyclic carbonate ester, chain carbonate ester, and cyclic carboxylate ester may be mentioned. For cyclic carbonate ester, for example, propylene carbonate (PC) and ethylene carbonate (EC) may be mentioned. For chain carbonate ester, for example, diethyl carbonate (DEC), ethyl methyl carbonate (EMC), and dimethylcarbonate (DMC) may be mentioned. For cyclic carboxylate ester, for example, γ-butyrolactone (GBL) and γ-valerolactone (GVL) may be mentioned. The non-aqueous solvent may be used singly, or may be used in combination of two or more, as necessary.

For the additive, for example, those materials that improve charge and discharge efficiency, and materials that deactivate batteries may be mentioned. For the material that improves charge and discharge efficiency, may be mentioned are, for example, vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate (VEC), divinylethylene carbonate, and a compound in which a portion of hydrogen atoms is replaced with fluorine atoms. These may be used singly, or may be used in combination of two or more.

For the material that deactivates batteries, for example, a benzene compound including a phenyl group and a cyclic compound group adjacent to the phenyl group may be mentioned. For the cyclic compound group, for example, a phenyl group, a cyclic ether group, a cyclic ester group, a cycloalkyl group, and a phenoxy group are preferable. Specific examples of the benzene compound include, for example, cyclohexyl benzene (CHB) and modified CHB, biphenyl, and diphenylether may be mentioned. These may be used singly, or may be used in combination of two or more. However, the benzene compound content in a liquid non-aqueous electrolyte is preferably 10 parts by volume or less relative to 100 parts by volume of the non-aqueous solvent.

The gelled non-aqueous electrolyte includes a liquid non-aqueous electrolyte and a polymer material for retaining the liquid non-aqueous electrolyte. The polymer material used here is able to gellatinize a liquid. For the polymer material, those usually used in this field may be used. For example, polyvinylidene fluoride, polyacrylonitrile, polyethylene oxide, polyvinyl chloride, polyacrylate, and polyvinylidene fluoride may be mentioned.

The solid electrolyte includes, for example, a supporting salt and a polymer material. For the supporting salt, those mentioned as examples in the above may be used. For the polymer material, for example, polyethyleneoxide (PEO), polypropyleneoxide (PPO), and a copolymer of ethyleneoxide and propyleneoxide may be mentioned.

A non-aqueous electrolyte secondary battery of the present invention may be applied for use same as conventional non-aqueous electrolyte secondary batteries. When a non-aqueous electrolyte secondary battery of the present invention is a lithium ion secondary battery, for example, it is useful for a power source for mobile electronic devices and transportation devices, and uninterruptible power sources. The mobile electronic devices include, for example, mobile phones, mobile personal computers, personal data assistants (PDA), and mobile game machines.

In the following, the present invention is described in detail based on Examples. Although a lithium ion secondary battery is used as a non-aqueous electrolyte secondary battery for describing Examples of the present invention in detail, the description is an example and the present invention is not limited to these Examples.

### EXAMPLE 1

(a) Positive Electrode Preparation

A positive electrode mixture slurry was prepared by stirring and mixing 3 kg of lithium cobaltate, i.e., a positive electrode active material; 1 kg of an NMP solution dissolving 12 wt % of PVDF (product name: #1320, manufactured by KUREHA CORPORATION), i.e., a positive electrode binder; 90 g of acetylene black, i.e., a conductive agent; and an appropriate amount of NMP with a double-armed kneader. This slurry was applied on both sides of an aluminum foil with a thickness of 15 μm, i.e., a positive electrode current collector, except for a portion to be connected with a positive electrode lead. After the slurry was dried, the obtained film was rolled with a roller, to form a positive electrode active material layer with a positive electrode active material density of 3.3 g/cm³. The thickness of a positive electrode plate comprising the aluminum foil and the positive electrode active material layer was set to 160 μm. Afterwards, the positive electrode plate was slit to set its width to 56 mm, i.e., a width that can be inserted to a battery can of a cylindrical battery (a diameter of 18 mm and a length of 65 mm). This positive electrode plate was wound to make a reel-like rolled product (hoop) of the positive electrode plate.

(b) Negative Electrode Preparation

A negative electrode mixture slurry was prepared by stirring and mixing 3 kg of artificial graphite, i.e., a negative electrode active material; 75 g of an aqueous dispersion of a 40 wt % modified styrene-butadiene copolymer (product name: BM-400B, manufactured by Zeon Corporation) i.e., a negative electrode binder; 30 g of CMC as a thickener; and an appropriate amount of water with a double-armed kneader. This slurry was applied on both sides of a copper foil with a thickness of 10 μm, i.e., a negative electrode current collector, except for a portion to be connected with a negative electrode lead. After the slurry was dried, the obtained film was rolled with a roller, to form a negative electrode active material layer with a negative electrode active material density of 1.4 g/cm³. The thickness of a negative electrode plate comprising the copper foil and the negative electrode active material layer was set to 180 μm. Afterwards, the negative electrode plate was slit to set its width to 58 mm, i.e., a width that can be inserted to a battery can of a cylindrical battery (a diameter of 18 mm and a length of 65 mm). This negative electrode plate was wound to make a reel-like rolled product (hoop) of the negative electrode plate.

(c) Separator Preparation

A mixture was made by kneading 35 parts by weight of high density polyethylene with a weight average molecular weight of 600000; 10 parts by weight low density of polyethylene with a weight average molecular weight of 200000; and 55 parts by weight of dioctyl phthalate (plasticizer). The obtained mixture was put into an extruder with a T-die attached to an end thereof, melted, and kneaded to extrude from the T-die, to form a sheet having a thickness of 100 μm. This sheet was immersed in methylethylketone to extract and remove dioctyl phthalate, and dried, thereby making a pre-drawing porous film. This porous film was biaxially drawn to 7×7 in a heater with its temperature kept to 120 to 125° C., and heated afterwards in a heater with its temperature kept to 110° C., thereby making a polyethylene-made porous film (microporous film).

A polar solvent solution of an aramid resin was prepared next. To 100 parts by weight of NMP, 6.5 parts by weight of dried anhydrous calcium chloride was added, and heated to a temperature of 80° C. in a reaction vessel to completely dissolve anhydrous calcium chloride in NMP. After this NMP solution of calcium chloride was cooled to give room temperature, 3.2 parts by weight of p-phenylenediamine was added and completely dissolved. The reaction vessel was put into a constant temperature bath of 20° C., 5.8 parts by weight of dichloride terephthalate was dropped for an hour in the NMP solution of calcium chloride and p-phenylenediamine, for polymerization, thereby synthesizing polyparaphenylene terephthalamide (hereinafter referred to as “PPTA”), i.e., an aramid resin. Afterwards, the reaction vessel was allowed to stand for an hour in a constant temperature bath of 20° C., and the contents were put into a vacuum vessel, and stirred for 30 minutes under reduced pressure to degas. The obtained polymerized liquid was further diluted with an NMP solution of calcium chloride. An NMP solution of an aramid resin with PPTA concentration of 1.4 wt % was prepared.

This NMP solution of an aramid resin was thinly applied on the polyethylene-made porous film obtained above with a doctor blade. The obtained coating was dried with hot blast of 80° C. (wind speed of 0.5 m/sec), to form a layered film. This layered film was sufficiently washed with pure water to remove calcium chloride while giving porosity to the aramid resin layer, and dried. A layered film of an aramid-made heat-resistant porous film and a polyethylene-made porous film, i.e., separator body, was thus made.

To both surfaces of the separator body in its thickness direction, an aqueous solution of 50 wt % N,N,N-trimethyl-n-(2-hydroxy-3-methacryloyloxypropyl)ammonium chloride (product name: Blemmer QA, manufactured by NOF CORPORATION, cationic surfactant) i.e., an antistatic agent, was applied with a spray and dried to form an antistatic layer, thereby making a separator (first separator) of the present invention. The amount of the antistatic agent at the separator surface was 0.01 g/m², and the ratio of the antistatic agent relative to the amount of resin in total included in the separator body was 0.1 wt %. This separator was slit so that its width was 60 mm, and wound to make a reel-like rolled product (hoop) of the separator.

(d) Non-aqueous Electrolyte Liquid Preparation

A non-aqueous solvent was prepared by mixing ethylene carbonate (EC), dimethylcarbonate (DMC), and ethyl methyl carbonate (EMC) with a volume ratio of 2:3:3. In this non-aqueous solvent, LiPF₆ was dissolved with a concentration of 1 mol/L. To 100 parts by weight of this solution, 3 parts by weight of vinylene carbonate (VC) was added, thereby making a non-aqueous electrolyte liquid.

(e) Battery Preparation

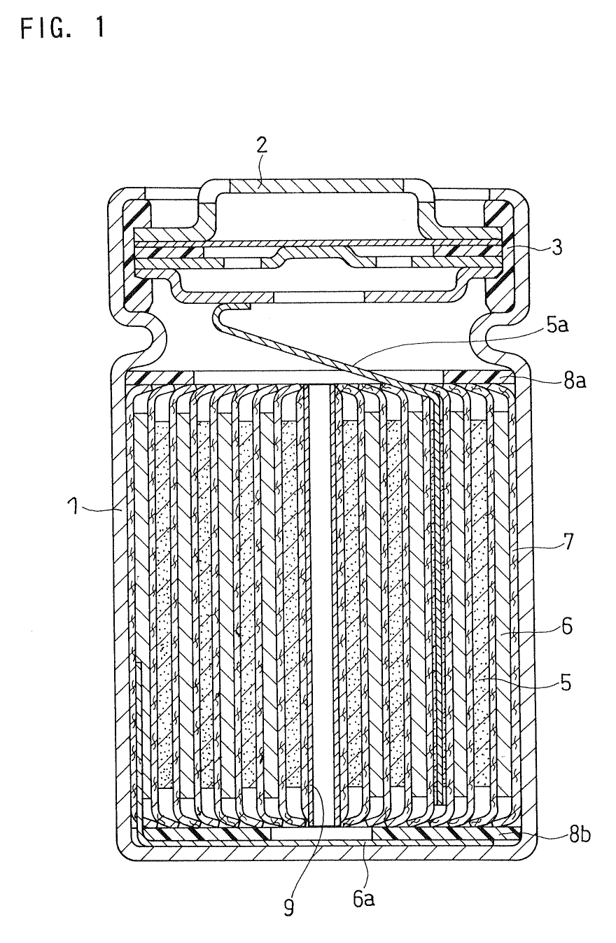

A cylindrical battery having the structure shown in FIG. 1 was made as described below, by using the above-obtained positive electrode 5, negative electrode 6, separator 7, and non-aqueous electrolyte liquid. FIG. 1 is a schematic cross section view showing the structure of a lithium ion secondary battery in an embodiment of the present invention.

First, the positive electrode 5 and the negative electrode 6 were cut to give a predetermined length. To a lead-connecting portion of the positive electrode 5, an end of the positive electrode lead 5a was connected, and to a lead connecting portion of the negative electrode 6, an end of the negative electrode lead 6a was connected. Afterwards, the positive electrode 5, the negative electrode 6, and the separator 7 were wound, to form a cylindrical electrode assembly with its outermost perimeter covered with the separator 7. The speed for rolling out the separator hoop was set to 2 hoops/min (load of 500 gf).

This electrode assembly was sandwiched with an upper insulating ring 8a and a lower insulating ring 8b, and then inserted into a battery can 1. Then, after 5 g of the above non-aqueous electrolyte liquid was injected in the battery can, the pressure was reduced to 133 Pa. The battery can was allowed to stand until the electrode assembly surface showed no electrolyte liquid remaining, for immersing the electrode assembly in the electrolyte.

Afterwards, the positive electrode lead 5a was welded to the reverse side of a battery lid 2, and the negative electrode lead 6a was welded to the inner bottom side of the battery can 1. Lastly, the opening of the battery can was closed with a battery lid 2 with an insulating packing 3 at its rim, thereby making a cylindrical lithium ion secondary battery of Example 1 having a theoretical capacity of 2 Ah.

### EXAMPLE 2

A separator (second separator) was made in the same manner as Example 1, except that an antistatic agent was added to the polyethylene-made porous film instead of applying the antistatic agent with spray, and a cylindrical lithium ion secondary battery of Example 2 was made.

The antistatic agent was added to the polyethylene-made porous film as in below. To a melted, kneaded material including 35 parts by weight of high density polyethylene with a weight average molecular weight of 600000, 10 parts by weight of low density polyethylene with a weight average molecular weight of 200000, and 55 parts by weight of dioctyl phthalate (plasticizer), 0.1 wt % of sodium isoprene sulfonate (IPS manufactured by JSR, antistatic agent) was added relative to the amount of polyethylene resin, and afterwards, a polyethylene-made porous film containing an antistatic agent inside was made in the same manner as Example 1.

### COMPARATIVE EXAMPLE 1

A cylindrical lithium ion secondary battery of Comparative Example 1 was made in the same manner as Example 1, except that the antistatic agent was not used.

### COMPARATIVE EXAMPLE 2

A cylindrical lithium ion secondary battery of Comparative Example 2 was made in the same manner as Comparative Example 1, except that the aramid resin-made heat-resistant porous film was not stacked.

### COMPARATIVE EXAMPLE 3

A cylindrical lithium ion secondary battery of Comparative Example 3 was made in the same manner as Example 2, except that the aramid resin-made heat-resistant porous film was not stacked.

In this Example, the electrode assembly was formed in an environment with more dust than in usual manufacturing steps for clearly showing a minute short circuit defect (OCV defect) in the following. To be specific, the electrode assembly was formed in an environment with a clean level of 100000 with dust having a diameter of 0.3 μm or more by measured result of a particle counter, and including carbon, iron, tin, nickel, aluminum, copper, and silicon as dust.

The following evaluations were carried out for 100 cylindrical lithium ion secondary batteries obtained in each of Examples 1 to 2 and Comparative Examples 1 to 3. The results are shown in Table 1.

### [Misalignment in Winding]

The obtained electrode assemblies were visually checked, and determined as a battery with winding misalignment when even a portion of the negative electrode was exposed in its width direction. The percentage was obtained from the number of the winding misalignment.

### [OCV Defect]

Preliminary charge and discharge were carried out twice by carrying out (1) and (2) twice, and charge and discharge of (3) to (6) were carried out afterwards to bring the battery into a charged state with a charging voltage of 4.1 V. Afterwards, the battery was stored for 7 days under an environment with 45° C. as an aging process.

(1) Constant Current Discharge: 400 mA (End Voltage 3 V)

(2) Constant Current Charge: 1400 mA (End Voltage 4.2 V)

(3) Constant Voltage Charge: 4.1 V (End Current 100 mA)

(4) Constant Current Discharge: 2000 mA (End Voltage 3 V)

(5) Constant Current Charge: 1400 mA (End Voltage 4.2 V)

(6) Constant Voltage Charge: 4.1 V (End Current 100 mA)

An open circuit voltage (OCV) was measured before and after the aging, and the difference between the pre-charge OCV and post-charge OCV was obtained and named ΔOCV. Afterwards, the average value of ΔOCV value was calculated, and those batteries showing ΔOCV value of 5 mV or less lower than the average value was considered as those batteries with occurrence of minute short circuit defect (OCV defect), and from its number of defects, percentage was obtained.

TABLE 1

| | | | | Winding | OVC |
|---|---|---|---|---|---|
| | | Antistatic | Method for | Misalignment | Defect |
| | Separator | Agent | Addition | (%) | (%) |
| Ex. 1 | Layered | Ammonium | Application on Surface | 0 | 1 |
| | Film*¹ | Salt*² | | | |
| Ex. 2 | Layered | Sodium | Upon Extrusion | 0 | 2 |
| | Film*¹ | Isoprene | | | |
| | | Sulfonate | | | |
| Comp. | Layered | — | — | 15 | 35 |
| Ex. 1 | Film*¹ | | | | |
| Comp. | Polyethylene- | — | — | 0 | 8 |
| Ex. 2 | made Porous | | | | |
| | Film | | | | |
| Comp. | Polyethylene- | Sodium | Upon Extrusion | 0 | 5 |
| Ex. 3 | made Porous | Isoprene | | | |
| | Film | Sulfonate | | | |

*¹a layered film of an aramid resin-made heat-resistant porous film and a polyethylene-made porous film
*²N,N,N-trimethyl-n-(2-hydroxy-3-methacryloyloxypropyl)ammonium chloride

With the separator including a heat-resistant porous film comprising an aromatic resin, as in Comparative Example 1, electrostatic occurs upon rolling out the separator from the reel for making a battery assembly, and in many batteries, separator largely meandered to cause misalignment. From the comparison with Comparative Example 2, it is clear that such a defect is specific to the case when the heat-resistant porous film comprising aromatic resin is included. By including an antistatic agent while utilizing an aromatic resin, as in Examples 1 and 2, the defect of winding misalignment was drastically improved with effective removal of electric charge. Additionally, as a secondary effect of including the antistatic agent, dust does not easily attach to the separator upon forming the electrode assembly, the OCV defect was also improved significantly. However, in Comparative Example 3, despite using the above antistatic agent, number of the OCV defect occurrence was quite large. This is probably because in the case of Examples 1 to 2, even when a minute amount of dust remained in the electrode assembly, with a high heat-resistance aromatic resin, the separator melting at the minute short circuit portion to lead to an OCV defect is prevented, whereas in Comparative Example 3, such effects cannot be brought out.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising a positive electrode, a negative electrode, and a separator containing an aromatic resin and an antistatic agent.

2. The non-aqueous electrolyte secondary battery in accordance with claim 1, wherein said aromatic resin contains at least one bond selected from the group consisting of an aramid bond, an amide-imide bond, an amide bond, an imide bond, a sulfide bond, and a carbonyl bond in its molecule.

3. The non-aqueous electrolyte secondary battery in accordance with claim 1, wherein said aromatic resin is at least one selected from the group consisting of an aramid resin, polyamide-imide, and polyimide.

4. The non-aqueous electrolyte secondary battery in accordance with claim 1, wherein said separator includes a separator body and an antistatic layer provided at least one side of said separator body in the thickness direction thereof.

5. The non-aqueous electrolyte secondary battery in accordance with claim 1, wherein said separator contains an antistatic agent in said separator body.

6. The non-aqueous electrolyte secondary battery in accordance with claim 1, wherein said antistatic agent has a molecular weight of 10000 or less.

7. The non-aqueous electrolyte secondary battery in accordance with claim 1, wherein said antistatic agent is at least one selected from the group consisting of an anionic surfactant, a cationic surfactant, an amphoteric surfactant, and a non-ionic surfactant.

8. The non-aqueous electrolyte secondary battery in accordance with claim 1, wherein said non-aqueous electrolyte is a non-aqueous electrolyte liquid.
